(19) United States
(12) Patent Application Publication
(10) Pub. No.: US 2020/0050980 A1
(43) Pub. Date: Feb. 13, 2020

(54) UNIVERSAL TRACKING SYSTEM FOR VENDOR- CUSTOMER COMMUNICATION

(71) Applicants: PRORIGO SOFTWARE PVT. LTD., Pune (IN); PRORIGO SOFTWARE CANADA LTD., Brampton, ON (CA)

(72) Inventors: Sreenivas LYSETTI, Brampton (CA); Kaustubh KARANDIKAR, Pune (IN)

(73) Assignees: PRORIGO SOFTWARE PVT. LTD., Pune (IN); PRORIGO SOFTWARE CANADA LTD., Brampton, ON (CA)

(21) Appl. No.: 16/343,080

(22) PCT Filed: Oct. 20, 2017
(86) PCT No.: PCT/IN17/50486

§ 371 Date: Apr. 18, 2019

(30) Foreign Application Priority Data
Oct. 23, 2016 (IN) 201621032467

(51) Int. Cl. G06Q 10/06; G06Q 30/00; G06Q 30/02; G08B 21/22; H04L 29/08; H04L 29/06; G06Q 10/10

(52) U.S. Cl. CPC G06Q 10/06; G06Q 30/016; G06Q 30/0281; G06Q 30/0282; G06Q 10/10; H04L 67/02; H04L 67/42; H04L 67/10; G08B 21/22

(57) ABSTRACT

A universal tracking system for business-customer communication provides a current status of a plurality of subjects (jobs) to the customers and business at any point of time on their cellular devices wherein the subject is tracked based on a plurality of predefined states (lifecycle), locations and pictures being posted on the subject in a chronological order. The universal tracking system facilitates a single dashboard to the customers that lists all the subjects they are dealing with multiple businesses in a single native application wherein communication between businesses and customers in the context of the subjects is tracked through the system. The universal tracking system allows accessing completed subjects and communication that happened during the subject execution to be referred in future. The universal tracking system facilitates creation of groups that involve multiple customers which can be handled with minimal effort through a single communication channel.

### FIELD OF THE INVENTION

The present invention relates to computerized cellular telecommunication based e-business systems and more particularly to a computerized cellular tracking system for tracking any subject from any business with predefined states (lifecycle), geolocation, and pictures along with instant messaging.

### BACKGROUND OF THE INVENTION

In conventional e-commerce and in-shop purchases, the communication between customers and businesses takes place through various communication means such as SMS, telephone calls, or personal visits to business till the product or service is fulfilled. However, based on the type of product or service it may take days, weeks or even months before the product or service is fulfilled. During this period, customer often needs to track progress made by business in fulfilling the product or service.

In case where the customer is dealing with multiple businesses then keeping track of communication with multiple businesses can be a challenging task. Also every time customer or businesses contact each other, they need to set the context before discussing the required thing. If the communication is happening verbally, there is no system of record for what is agreed upon. During fulfillment of product or service if the customer is not available for communication, passing the information to other person to communicate on his behalf is challenging since all the communication that happened previously in not stored at a single place. At times, the customer may want to involve another family member or friend to be a part of the communication that is going on with the business. In such cases, setting the context again and keeping all the parties on the same page of communication can prove to be a challenging task.

There is also a need to collect feedback on the delivered product or rendered service to guarantee customer satisfaction. Customers have to keep all the bills and notes handy at all the time in order to contact business in future on the delivered product or rendered service, which is often a complex task.

In industries like education and construction, there is a need to mass communicate with customers involved in a group or a project. This communication is happening today through emails and SMS. Tracking what all communicated over the period of time is little challenging since these emails are scattered all over the place without a context. It becomes particularly more challenging if there are multiple employees involved at the business end in the communication.

Currently known subject tracking systems can enable the user to track the subjects only with a specific business cellular app. These tracking systems fail to track subjects with multiple businesses as the user has to install multiple native applications on his cellular device. Moreover, the currently known subject tracking systems fail to set any roles for the communication between the customers and businesses as both the parties involved in the communication are at equal level. In addition, currently known subject tracking systems which involve instant messaging solutions such as WhatsApp, Skype, Yahoo Messenger and the like may facilitate communication with the business to a very limited context. In such messaging solutions, the users have to personally set the context before they start the actual communication. In these messaging solutions messages can be broadcasted by creating groups however these systems fail to maintain confidentiality of the information as the messages posted by any user can be seen by all other users in that group.

Accordingly, there is need of universal tracking system for vendor/business-customer communication that overcomes all the drawbacks of the prior art.

### SUMMARY OF THE INVENTION

The present invention provides a universal tracking system for business-customer communication that comprises a customer mobile application component and a business mobile application component configured to be pre-installed on a preconfigured memory of a communication device. The preconfigured memory executes a plurality of instructions via a communication device with regard to a plurality of subjects of the customers and businesses. The customer mobile application component, the business mobile application component and the business admin web client communicate to a cloud server through internet. The cloud server includes a system XMPP server, a system web server, a cloud file storage service, a system API server, a message queue, an event queue, a messaging cache, a system message persister, a system database and a file storage database for serving all kinds of requests coming from the customer mobile application component, business mobile application component and business admin web client.

The customer mobile application component includes a frontend, a business layer and a backend, the frontend has a native user interface, a notification panel and a camera. The business layer has a customer verification/validation module, a QR code scanner module, a subject and group data handler, a messaging client module, a file handler module, a geolocation handler module, a feedback handler module, a subject share module and a local cache handler module. The backend has a local cache database and a processor.

The business mobile application component includes a frontend, a business layer and a backend. The frontend has a native user interface, a notification panel and a camera.

The business layer has a business employee authentication module, a QR code scanner module, a subject and group data handler, a messaging client module, a file handler module, a geolocation handler module, a feedback handler module, an image markup handler module and a local cache handler module. The backend has a local cache database and a processor.

The business admin web client component includes a frontend and a backend. The frontend has an HTML5 user interface and a notifications panel. The backend has a business employee authentication module, a subject/group/feedback template creator module, an organization data handler module, a subject and group creator module, a subject and group data handler module, a JavaScript messaging client module, a file handler module, a geolocation handler module and a feedback handler module.

The system XMPP server has an internal logic that resolves and decides to whom the message has to be broadcasted based on the context such as Subject or Group. The system XMPP server is configured to write the message to Message Queue in order for Message Persister to persist the message in System database. The message queue collects all messages related to Subjects, Groups, and ad-hoc messaging from XMPP server and delivers the same to all subscribers such as the message persister thereby enabling asynchronous communication among the components of the cloud server without tight dependencies between components thereof. The system web server and API server publishes events to Event Queue based on the various updates taking place on the cloud server. The event queue is configured to collect various such events and subsequently communicates the same to the system XMPP server. The system XMPP server handles the events from the Event Queue and propagates the same to the relevant clients. The feedback handler module creates a feedback form when the subject is ready for feedback and subsequently collects the feedback from the customer. The feedback handler module shows collected feedback to business employees. The subject share module allows sharing existing customer subjects with his/her friends and family members thereby allowing private communication within the shared subjects. The image markup handler module is designed to help business employees in marking up the image captured through camera or loaded from gallery, with text and symbols before sharing the image as part of subject and group messaging.

### BRIEF DESCRIPTION OF DRAWINGS

FIG. 1 is an environmental representation of a universal tracking system for business-customer communication in accordance with the present invention;

FIG. 2 is an architectural representation of a customer mobile application component of the universal tracking system for business-customer communication of FIG. 1;

FIG. 3 is an architectural representation of a business mobile application component of the universal tracking system for business-customer communication of FIG. 1;

FIG. 4 is an architectural representation of a business admin web client component of the universal tracking system for business-customer communication of FIG. 1;

FIG. 5 is a flowchart showing creation of a feedback template for the universal tracking system for business-customer communication of FIG. 1;

FIG. 6 is a flowchart showing creation of a subject template for the universal tracking system for business-customer communication of FIG. 1;

FIG. 7 is a flowchart showing creation of a group template for the universal tracking system for business-customer communication of FIG. 1;

FIG. 8A is a flowchart showing a subject creation process of the universal tracking system for business-customer communication of FIG. 1;

FIG. 8B is a continued flowchart of the subject creation process of FIG. 8A;

FIG. 9A is a flowchart showing a group creation process of the universal tracking system for business-customer communication of FIG. 1; and

FIG. 9B is a continued flowchart of the group creation process of FIG. 9A.

### DESCRIPTION OF THE INVENTION

The invention described herein is explained using specific exemplary details for better understanding. However, the invention disclosed can be worked on by a person skilled in the art without the use of these specific details.

References in the specification to “one embodiment” or “an embodiment” means that a particular feature, structure, characteristic, or function described in connection with the embodiment is included in at least one embodiment of the invention. The appearances of the phrase “in one embodiment” in various places in the specification are not necessarily all referring to the same embodiment.

References in the specification to “preferred embodiment” means that a particular feature, structure, characteristic, or function described in detail thereby omitting known constructions and functions for clear description of the present invention.

The foregoing description of specific embodiments of the present invention has been presented for purposes of illustration and description. They are not intended to be exhaustive or to limit the present invention to the precise forms disclosed and obviously many modifications and variations are possible in light of the above teaching.

In the description and in the claims, the term “Subject” is defined broadly as any product or service provided by business to customer that is trackable by a universal tracking system of the present invention.

In the description and in the claims, the term “Group” is defined broadly as a collection of subjects that can be tracked together and communicated over by the universal tracking system of the present invention.

In the description and in the claims, the term “XMPP” is defined broadly as an eXtensible Messaging and Presence Protocol which is an open XML technology for real-time communication, which powers a wide range of applications including instant messaging, presence and collaboration.

In the description and in the claims, the term “API” is defined broadly as Application Programming Interface which is a set of clearly defined methods of communication between various software components of the universal tracking system of the present invention.

In the description and in the claims, the term “QR Code” is defined broadly as Quick Response Code which is a type of matrix barcode or two-dimensional barcode.

In the description and in the claims, the term “Message Queue” is defined broadly as a queue of messages sent between application components of the universal tracking system of the present invention.

In the description and in the claims, the term “Event Queue” is defined broadly as a queue of events sent between application components of the universal tracking system of the present invention.

In the description and in the claims, the term “Template” is defined broadly as business defined schema with list of fields and lifecycle states to facilitate tracking subjects and groups of the business.

Accordingly, the present invention defines a universal tracking system that provides a current status of a plurality of subjects (jobs) to the customers and businesses (vendors) at any point of time on their cellular devices. In the context of the present invention, the subject is tracked based on a plurality of predefined states (lifecycle), a plurality of geographical locations and a plurality of pictures posted on the subject in a chronological order. The universal tracking system of the present invention facilitates a single dashboard to the customers that lists all the subjects they are dealing with multiple businesses in a single native application. The universal tracking system of the present invention facilitates communication between businesses and customers in the context of the subjects being tracked through the system. The universal tracking system allows accessing completed subjects and communication that happened during the subject execution to be referred in future. The universal tracking system of the present invention facilitates creation of groups that involve multiple customers which can be handled with minimal effort with a single communication channel.

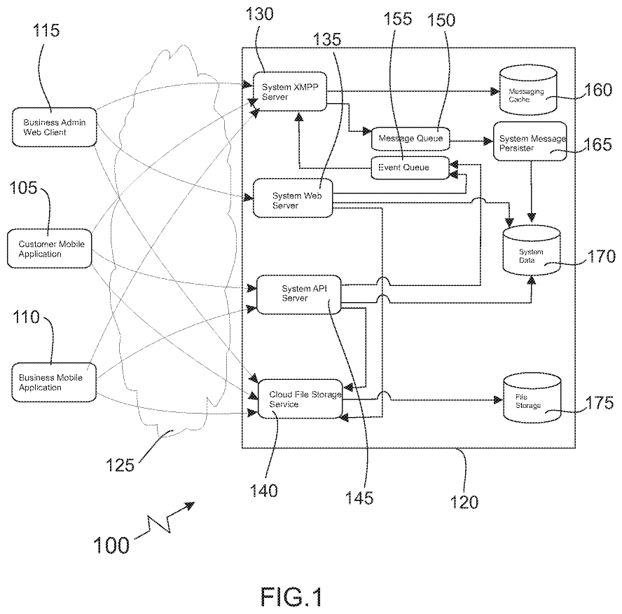

Referring to FIG. 1, an environment 100 designed for the universal tracking system of the present invention includes a customer mobile application component 105 and a business mobile application component 110 are configured to be pre-installed on a preconfigured memory of a communication device that is embedded with the universal tracking system of the present invention. The preconfigured memory executes a plurality of instructions via the communication device with regard to the plurality of subjects of the customers and businesses. The customer mobile application component 105, the business mobile application component 110 and a business admin web client 115 communicate to a cloud server 120 through internet 125 as illustrated. The cloud server 120 includes a system XMPP server 130, a system web server 135, a cloud file storage service 140, a system API server 145, a message queue 150, an event queue 155, a messaging cache 160, a system message persister 165, a system database 170 and a file storage database 175 that are responsible for serving all kinds of requests coming from the customer mobile application component 105, the business mobile application component 110 and the business admin web client 115.

The system XMPP server 130 is configured to serve any requests related to Subjects, Groups, and ad-hoc real-time messaging. The system XMPP server 130 has an internal logic to resolve and decide to whom the message has to be broadcasted based on the context, such as for example Subject or Group. The system XMPP server 130 checks at the time of broadcasting if the client is offline and in such case caches and pushes the message when the client comes online in future. The system XMPP server 130 is configured to write the message to Message Queue in order for Message Persister to persist the message in System database 170. The system XMPP server 130 handles the events from the Event Queue 155 and propagates the same to the relevant clients.

The system web server 135 is configured to serve any requests coming from Business Admin Web Client 115 related to Subjects, Groups, Subject Templates, Group

Templates, Feedback Templates, Customers, and Employees. The system web server 135 has a preconfigured logic to register the Business first time and facilitate further assistance in the environment 100. Based on the permissions given to business employee, he/she is authorized to perform specific tasks from the user interface. The system web server 135 is also responsible to publish events to Event Queue 155 based on the various updates taking place on the cloud server 120. The system API server 145 is configured to serve any REST API requests coming from Business and Customer Mobile Applications 105 related to Subject, Groups, Feedback, Customers, and Businesss. It is also responsible to publish events to Event Queue based on the various updates taking place on the cloud server 120. The cloud file storage service 140 is an external service provided by cloud providers, such as Amazon, Azure and the like. Client applications use cloud file storage service 140 to store and retrieve attachments using Valet Key Pattern.

The message queue 150 collects all messages related to Subjects, Groups, and ad-hoc messaging from XMPP server 130 and deliver the same to all subscribers such as the message persister 165 thereby enabling asynchronous communication among the components of the cloud server 120 without tight dependencies between components thereof.

The event queue 155 is configured to collect various events published from system web server 135 and API server 145 related to updates that occurred on Subjects, Groups, Customers, and Business Employees and subsequently communicates the same to the XMPP server 130.

The messaging cache 160 is responsible for persisting undelivered messages from system XMPP server 130 to offline clients.

The system message persister 165 is configured to handle persisting messages posted on Subjects, Groups, and ad-hoc messaging to system database 170.

The system database 170 stores and retrieves all kinds of data related to Subjects, Groups, Feedback, Subject Templates, Group Templates, Feedback Templates, Business Employees, Customers, and Business Organization.

The file storage 175 stores and retrieves attachments related to Subjects and Groups messaging. The file storage 175 is also responsible for storing and retrieving images related to customer profile and organization logo.

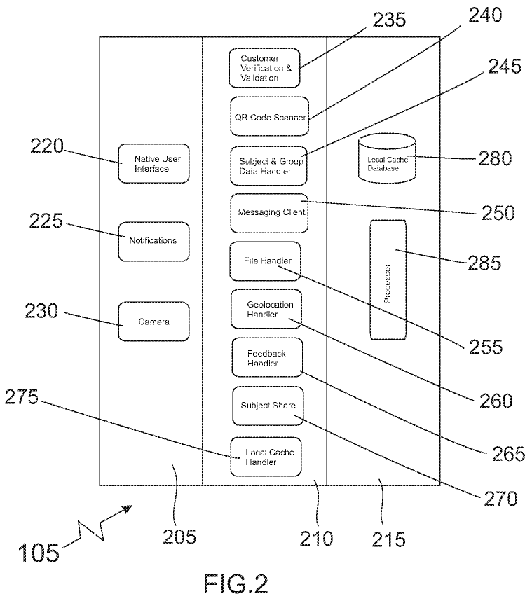

Referring to FIG. 2, the customer mobile application component 105 is adapted for customers who can access all the subjects they are dealing with various businesses from a single dashboard. The customer mobile application component 105 gives up-to-date status about the subjects to customers. The customer mobile application component 10 facilitates the customers to communicate with businesses in the context of subjects through messaging. The customer mobile application component 105 facilitates the customers to share the subjects with their friends and family members to communicate with businesses during their absence. The customer mobile application component 105 facilitates the customers to have the ability to give feedback about completed subjects. The customer mobile application component 105 facilitates the customers to access the data about subjects in offline and online modes.

The customer mobile application component 105 includes a frontend 205, a business layer 210 and a backend 215. The frontend 205 preferably defines a user interface of the customer mobile application component 105 that is accessible by the user. The frontend 205 includes a native user interface 220, a notification panel 225 and a camera 230. The business layer 210 includes a customer verification/validation module 235, a QR code scanner module 240, a subject and group data handler 245, a messaging client module 250, a file handler module 255, a geolocation handler module 260, a feedback handler module 265, a subject share module 270 and a local cache handler module 275. The backend 215 includes a local cache database 280 and a processor 285.

The native user interface 220 is configured to render the data related to Subjects, Messages, and Businesses in the form of various native user interface elements. The notification panel 225 is configured to show notifications related to any changes that occurred on the current user of the subject when the user is not actively using the customer mobile application component 105. The camera 230 reads QR code, and passes the data to QR code scanner module 240. The customer verification/validation module 235 verifies the customer as part of registration process and validates the customer on subsequent application launches. The QR code scanner module 240 is configured to read the QR code through Camera component and validate the same after being accessed by right customer. The QR code scanner module 240 is also configured to retrieve Subject details from the cloud server 120. The subject and group data handler 245 is responsible to retrieve the data related to subjects and groups from the cloud server 120. The subject and group data handler 245 stores the data in the local cache by communicating with the local cache handler module 275 and stores the same in sync with server copy by subscribing to events. The messaging client module 250 is configured to handle all XMPP messaging related to subjects, groups, and ad-hoc messages. The file handler module 255 is configured to handle attachments, such as file uploads and downloads, which are being shared as part of messaging related to subjects, groups, and ad-hoc messages. The geolocation handler module 260 renders geolocation of Subjects and Groups using Google Maps API when these objects are being tracked by geo-coordinates. The feedback handler module 265 shows a feedback form when the subject is ready for feedback and subsequently collects the feedback. The subject share module 270 allows sharing existing customer subjects with his/her friends and family members thereby allowing private communication within the shared subjects. The messages marked as private are not visible to the business in accordance with the present invention. The local cache handler module 275 is configured for caching the data related to Subjects, Groups, and Businesses. The local cache handler module 275 helps application to run in offline mode based on the data it received when it was online last time. The local cache handler module 275 is also responsible in synchronizing the data when the application has active internet connection. The local cache database 280 is configured to store and retrieve the cached data related to Subjects, Groups, and ad-hoc messages to and from the local persistent storage. The processor 285 acts as a mediator between the cloud server 120 and customer mobile application component 105.

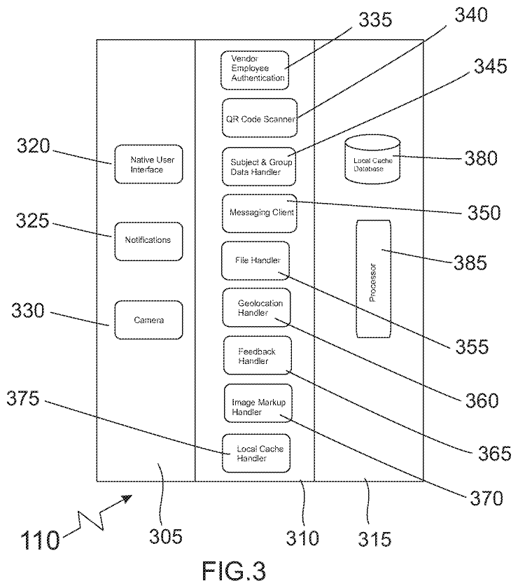

Referring to FIG. 3, the business mobile application component 110 is adapted for business employees who can access all Subjects and Groups they are dealing with various customers through a single dashboard. The business mobile application component 110 allows business employees to update State, Geolocation, and upload pictures, on the Subjects and Groups. The business mobile application component 110 allows business employees to communicate with customers over the Subjects and Groups. The business mobile application component 110 allows the business employees to review feedback submitted by customers on the completed Subjects and Groups. The business mobile application component 110 allows the business employees to access the data about Subjects and Groups in offline and online modes.

The business mobile application component 110 includes a frontend 305, a business layer 310 and a backend 315. The frontend 305 preferably defines a user interface of the business mobile application component 105 that is accessible by the user. The frontend 305 includes a native user interface 320, a notification panel 325 and a camera 330. The business layer 310 includes a business employee authentication module 335, a QR code scanner module 340, a subject and group data handler 345, a messaging client module 350, a file handler module 355, a geolocation handler module 360, a feedback handler module 365, an image markup handler module 370 and a local cache handler module 375. The backend 215 includes a local cache database 380 and a processor 385.

The native user interface 320 is responsible for rendering the data related to Subjects, Groups, and Customers in the form of various native user interface elements. The notification panel 325 is configured to show notifications related to any changes that occurred on the subjects current user is dealing with, when he/she is not actively using the application. The camera 330 activates the camera, reads QR code, and passes the data to QR code scanner 340. The business employee authentication module 335 is adapted to facilitate first time authentication of the business employee based on user name and password. The business employee authentication module 335 requests access token from the cloud server 120 and validates said access token on the subsequent application launches. The QR code scanner module 340 reads the QR code through Camera component 330 and validates if it is being accessed by right employee, and retrieve Subject details from the cloud server 120. The subject and group data handler 345 retrieves the data related to Subjects and Groups from the cloud server 120 and stores said data in the local cache database 380 thereby keeping it in sync with server copy. The messaging client module 350 is responsible to handle all XMPP messaging related to Subjects, Groups, and ad-hoc messages. The file handler module 355 is configured to handle attachments, such as file uploads and downloads, which are being shared as part of messaging related to Subjects, Groups, and ad-hoc messages. The geolocation handler module 360 is responsible for geo-locating Subjects and Groups, and subsequently rendering Geolocation using Google Maps API when these objects are being tracked by geo-coordinates. The feedback handler module 365 is configured to show collected feedback from the customer. The image markup handler module 370 is configured to help business employee in marking up the image, preferably captured through Camera or loaded from Gallery, with text and symbols before sharing the image as part of Subject and Group messaging. The local cache handler module 375 facilitates caching of the data related to Subjects, Groups, and Customers. The local cache handler module 375 helps application to run in offline mode based on the data it received when it was online last time. The local cache handler module 375 is also responsible in synchronizing the data when the application has active internet connection. The Local Cache Database 380 is configured to store and retrieve the cached data related to Subjects, Groups, and Customers to and from the local persistent storage. The processor 385 acts as a mediator between the cloud server 120 and the business mobile application component 110.

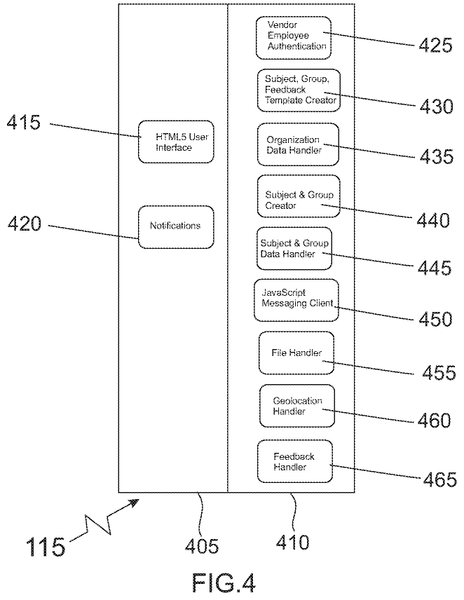

Referring to FIG. 4, the business admin web client component 115 is enables business admin and employees with special privileges to create templates for Subjects, Groups, and Feedback. The business admin web client component 115 gives an ability to create Subjects and Groups based on templates. The business admin web client component 115 enables admin and employees to update the State, Geolocation, and upload pictures on subjects and groups. The business admin web client component 115 allows admin and employees to communicate with customer over the Subjects and Groups. The business admin web client component 115 facilitates business employees an ability to review feedback submitted by customers on the completed subjects and groups. The business admin web client component 115 facilitates business employees to send promotional messages and greetings to customers on various occasions to run the marketing campaigns.

The business admin web client component 115 includes a frontend 405 and a backend 410. The frontend 405 includes an HTMLS user interface 415 and a notifications panel 420. The backend includes a business employee authentication module 425, a subject/group/feedback template creator module 430, an organization data handler module 435, a subject and group creator module 440, a subject and group data handler module 445, a JavaScript messaging client module 450, a file handler module 455, a geolocation handler module 460 and a feedback handler module 465.

The HTML5 User Interface 415 is configured to render the data related to Subjects, Groups, and Customers in the form of various HTML5 user interface elements using a plurality of predefined templates. The notifications panel 420 shows notifications related to any changes that occurred on the subjects and groups which current user is dealing with, while he is looking at other parts of the application.

The business employee authentication module 425 is configured to authenticate business employee based on user name and password. The subject/group/feedback template creator 430 helps business employees in managing templates related to Subject, Group, and Feedback. It is understood here that the templates created by the subject/group/feedback template creator module 430 are used for creating Subjects and Groups by other business employees. The organization data handler module 435 is responsible in creating and managing organization and its employees. The subject and group creator module 440 helps business employee in creating subjects and groups based on predefined templates. The subject and group data handler module 445 is responsible for retrieving the data related to subjects and groups from the server and subsequently modifying and saving the same on the server. The JavaScript messaging client module 450 handles all XMPP messaging related to Subjects, Groups, and ad-hoc messages. The file handler module 455 handles all attachments, such as file uploads and downloads, which are being shared as part of messaging related to subjects, groups, and ad-hoc messages. The geolocation handler module 460 is configured for geo-locating Subjects and Groups, and subsequently rendering Geolocation using Google Maps API when these objects are being tracked by geo-coordinates. The feedback handler module 465 manages the feedback being submitted by the customer. The feedback handler module 465 creates a feedback form when the subject is ready for feedback and subsequently the feedback handler module 265 collects the feedback from the customer. The feedback handler module 365 and the feedback handler module 465 are configured to show collected feedback to business employees.

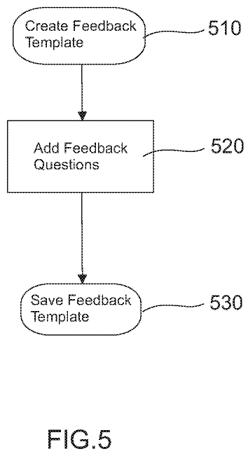

Referring to FIG. 5, a Feedback template creation flow designed for the business admin web client 115 is shown. In an initial step 510, a Feedback template form is created. In next step 520, a plurality of feedback questions is added in the feedback template by the business admin web client 115. In last step 530, the feedback template created by the business admin web client 115 is saved.

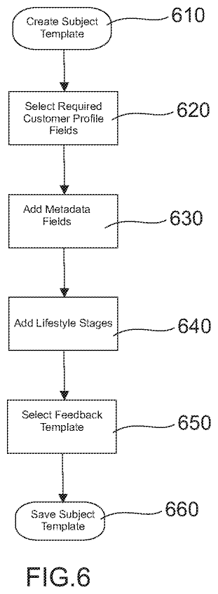

Referring to FIG. 6, a Subject template creation process designed for business admin web client 115 is shown. In an initial step 610, a Subject template is created. In next step 620, the business admin web client 115 selects required customer profile fields in the subject template. In further step 630, a plurality of metadata fields is added in the Subject template. In next step 640, a plurality of lifecycle states is added in the Subject template. In next step 650, the duly filled Subject template is selected and the same is saved in the database in final step 660.

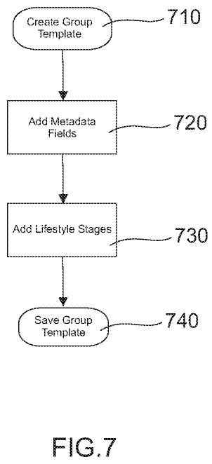

Referring to FIG. 7, a Group template creation process designed for business admin web client is shown wherein the Group template is created in an initial step 710. In next step 720, a plurality of metadata fields is added in the Group template. In next step 730, a plurality of lifecycle states is added in the Group template. In final step 740, the Group template is saved.

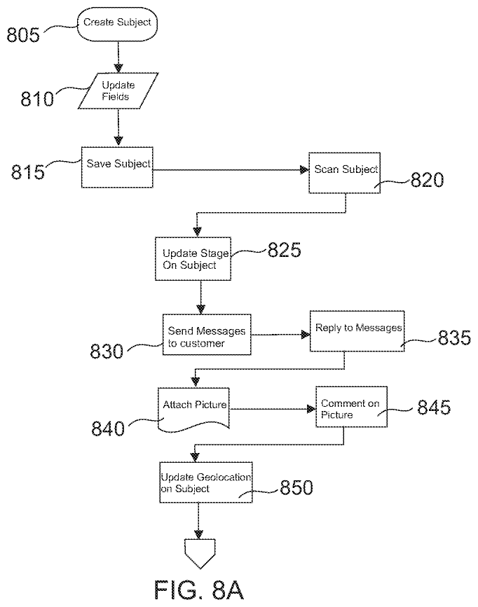

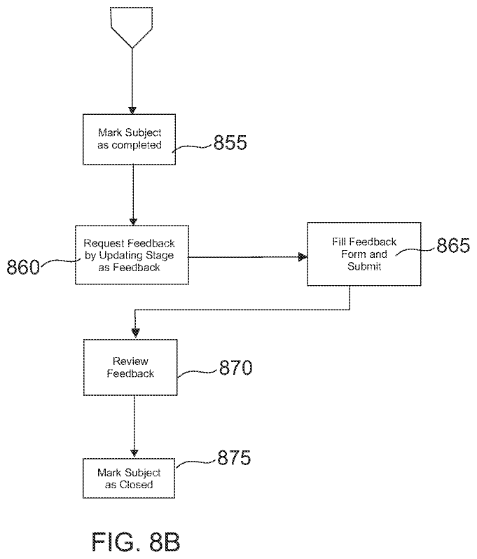

Referring to FIGS. 8A-8B, a Subject creation process in context of the present invention is shown. In an initial step 805 a Subject is created using a Subject template. In next step 810, a plurality of fields of the Subject in the subject template is updated and the Subject is saved in step 815. The Subject is scanned in next step 820 which is updated in next step 825. In next step 830, a plurality of messages is sent to the customer. In next step 835, a reply is received for the messages sent in earlier step 830. In next step 840, respective pictures are attached to the received messages. In further step 845, respective comments are received on the pictures based on which geolocation on the Subject is updated in next step 850. In next step 855, the Subject is marked as completed. In next step 860, a feedback is requested by updating state as feedback. In further step 865, the feedback form is filled up and submitted whose feedback is received in step 870. Accordingly, the Subject is marked as closed in final step 875.

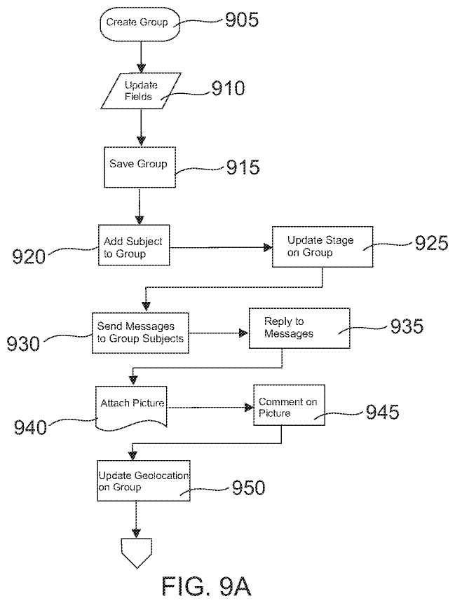

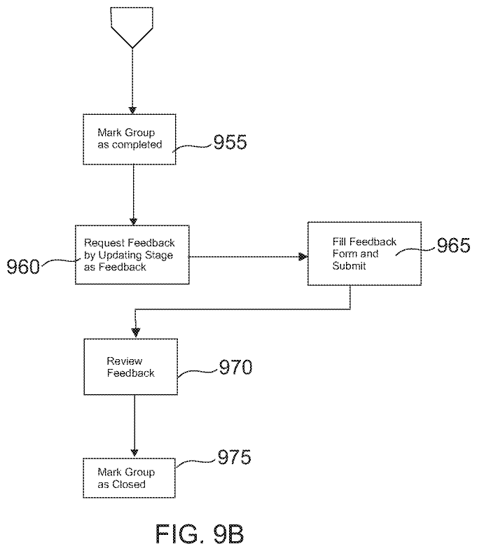

Referring to FIGS. 9A-9B, a Group creation process in context of the present invention is shown. In an initial step 905 a Group is created using the Group template. In next step 910, a plurality of fields in the Group template is updated in the Group template and subsequently the Group is saved in step 915. In next step 920, the Subject is added to the Group and subsequently updated in next step 925. In further step 930, a plurality of messages is sent Group Subjects whose reply is received in next step 935. In further step 940, respective picture is attached to the messages such that respective comment is received on the picture in next step 945. In further step 950, geolocation on the Group is updated and subsequently the Group is marked as completed in next step 955. In next step 960, a feedback is requested by updating state as feedback. In further step 965, the feedback form is filled up and submitted whose feedback is received in step 970. Accordingly, the Group is marked as closed in final step 975.

In operation, the universal tracking system for business-customer communication of the present invention facilitates a single dashboard wherein the customer has an access to all the Subjects being handled with various businesses at any point of time. The system of the present invention allows the Subjects to be tracked based on predefined states of lifecycle, geolocation, and progress being shown in the pictures associated with the Subjects. The system of the present invention eliminates the Customer to install pointed solutions from businesses to track their Subjects. The system of the present invention facilitates communication between business and customer through instant messaging which always happens with the subject in the context. The system of the present invention facilitates the businesses to communicate with multiple customers at the same time by creating groups. The system of the present invention facilitates the business to send promotional messages in a single click for multiple existing customers. The system of the present invention eliminates the need of exchange of contact information between business and customer as the information is exchanged as part of customer accepting the Subject created by the business through scanning QR code of the subject. The system of the present invention allows the Subject to be shared by customer with his family members/friends to take care of its progress in customer's absence. The system of the present invention facilitates the customer to put a private message on the subject that can be seen only by the people with whom the customer has shared his/her credentials. The system of the present invention allows the business employee to put a private message on the subject that can be seen only by his/her colleagues in the organization. The system of the present invention collects the contact information from customer only once as part of application registration and can be shared with multiple businesss upon approval from the customer while accepting the subject. The system of the present invention facilitates collection of feedback from the customer across multiple subjects thereby enabling reporting for the business.

The embodiments were chosen and described in order to best explain the principles of the present invention and its practical application, to thereby enable others, skilled in the art to best utilize the present invention and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the present invention.

1. A universal tracking system for business-customer communication comprising:
a customer mobile application component and a business mobile application component configured to be pre-installed on a preconfigured memory of a communication device, the preconfigured memory executing a plurality of instructions via a communication device with regard to a plurality of subjects of the customers and businesses, the customer mobile application component, the business mobile application component and a business admin web client communicating to a cloud server through internet,
the cloud server having a system XMPP server, a system web server, a cloud file storage service, a system API server, a message queue, an event queue, a messaging cache, a system message persister, a system database and a file storage database for serving all kinds of requests coming from the customer mobile application component, business mobile application component and business admin web client,
the customer mobile application component having a frontend, a business layer and a backend, the frontend having a native user interface, a notification panel and a camera, the business layer having a customer verification/validation module, a QR code scanner module, a subject and group data handler, a messaging client module, a file handler module, a geolocation handler module, a feedback handler module, a subject share module and a local cache handler module, the backend having a local cache database and a processor,
the business mobile application component having a frontend, a business layer and a backend, the frontend having a native user interface, a notification panel and a camera, the business layer having a business employee authentication module, a QR code scanner module, a
subject and group data handler, a messaging client module, a file handler module, a geolocation handler module, a feedback handler module, an image markup handler module and a local cache handler module, the backend having a local cache database and a processor,
the business admin web client component having a frontend and a backend, the frontend having an HTML5 user interface and a notifications panel, the backend having a business employee authentication module, a subject/group/feedback template creator module, an organization data handler module, a subject and group creator module, a subject and group data handler module, a JavaScript messaging client module, a file handler module, a geolocation handler module and a feedback handler module.

2. The system as claimed in claim 1, wherein the system XMPP server has an internal logic that resolves and decides to whom the message has to be broadcasted based on the context such as Subject or Group.

3. The system as claimed in claim 1, wherein the system web server publishes events to Event Queue based on the various updates taking place on the cloud server.

4. The system as claimed in claim 1, wherein the system XMPP server is configured to write the message to Message Queue in order for Message Persister to persist the message in System database.

5. The system as claimed in claim 1, wherein the message queue collects all messages related to Subjects, Groups, and ad-hoc messaging from XMPP server and delivers the same to all subscribers such as the message persister thereby enabling asynchronous communication among the components of the cloud server without tight dependencies between components thereof.

6. The system as claimed in claim 1, wherein the event queue is configured to collect various events published from system web server and API server and subsequently communicates the same to the system XMPP server.

7. The system as claimed in claim 1, wherein the system XMPP server handles the events from the Event Queue and propagates the same to the relevant clients.

8. The system as claimed in claim 1, wherein the feedback handler module creates a feedback form when the subject is ready for feedback and subsequently the feedback handler module collects the feedback from the customer such that the feedback handler module and the feedback handler module are configured to show collected feedback to business employees.

9. The system as claimed in claim 1, wherein the subject share module allows sharing existing customer subjects with his/her friends and family members thereby allowing private communication within the shared subjects.

10. The system as claimed in claim 1, wherein the image markup handler module is configured to help business employee in marking up the image captured through camera or loaded from gallery, with text and symbols before sharing the image as part of subjects and groups messaging.
